(19) United States
(12) Patent Application Publication
(10) Pub. No.: US 2026/0148914 A1
(43) Pub. Date: May 28, 2026

(54) Vacuum Circuit Breaker and Heat Transfer Assembly Therefor

(71) Applicant: Mitsubishi Electric Power Products, Inc., Warrendale, PA (US)

(72) Inventor: Paul J. Vladuchick, Cranberry Township, PA (US)

(73) Assignee: Mitsubishi Electric Power Products, Inc., Warrendale, PA (US)

(21) Appl. No.: 18/958,548

(22) Filed: Nov. 25, 2024

(51) Int. Cl. H01H 33/662; H01H 1/62; H01H 33/66; H01H 33/664

(52) U.S. Cl. CPC H01H 33/66261; H01H 1/62; H01H 33/6606; H01H 33/66207; H01H 33/664; H01H 2033/6613; H01H 2033/66284

(57) ABSTRACT

A heat transfer assembly for a vacuum circuit breaker includes a plate having a plurality of fins and adapted to be removably attached to a conductor casing, and a shield adapted to be removably connected to the conductor casing. The shield is arranged outwardly and surrounding the plate to contain electric field within a space defined between the shield and the plate. The shield includes a plurality of openings to allow a flow of an insulation gas between the space and exterior of the shield.

### TECHNICAL FIELD

The present disclosure relates, generally, to vacuum circuit breakers, and, more particularly, relates to a heat transfer assembly for a vacuum circuit breaker suitable to efficiently remove heat from the components of the vacuum circuit breaker.

### BACKGROUND

A vacuum circuit breaker (“VCB”) is a device that helps to prevent unintended currents caused by short circuits in electrical systems. It works by interrupting the current after a fault has been detected, thereby preventing damage to the system. Vacuum circuit breakers rely on a vacuum to extinguish the arc created when the circuit is tripped and the contacts move apart. VCBs work quickly and effectively, making them a solid choice for medium- and high-voltage systems.

Dead tank vacuum circuit breakers are high-performance switches that use dry air or other gas as an insulating medium, instead of sulfur hexachloride, a greenhouse gas. These devices are designed to be environmentally conscious and energy-saving, and can operate in extreme conditions. Some applications for dead tank vacuum circuit breakers include line, transformer, reactor, and capacitor switching, point-on-wave switching, as well as high seismic and high altitude applications.

Conventional dead tank vacuum circuit breakers typically include a dead tank and an interrupter unit arranged inside the dead tank with an insulated gas filled inside the dead tank to draw heat away from the interrupter unit and electrically insulate the dead tank from the interrupter unit. To facilitate an opening and closing of an electric circuit, the interrupter unit typically includes a stationary contact and a moving contact, each partially extending inside a vacuum sealed bottle and adapted to engage with each other and disengage from each other inside the vacuum sealed tube to close and open the circuit. Due to high continuous current rating, and reliance on arcing contacts, high amount of heat is generated during normal operation when the circuit is closed, and during opening of the circuit. Effectively drawing this heat away from vacuum circuit breakers (VCBs) is essential for several reasons:
Preventing Overheating: VCBs generate heat during operation, especially when carrying high continuous currents. If this heat isn't dissipated properly, it can lead to overheating, which can damage the VCB and reduce its lifespan.
Maintaining Performance: Excessive heat can limit the performance of the VCB. It can cause thermal expansion, which might lead to mechanical stresses and misalignment of components, impacting the breaker's ability to carry and interrupt current effectively.
Enhancing Efficiency: Efficient heat management ensures that the VCB operates at or below the maximum allowable temperature limits.
Thus, effective heat dissipation is important to ensuring the reliability, safety, and efficiency of vacuum circuit breakers. However, it is difficult to implement, at least because no convection heat transfer is possible within the vacuum sealed bottle.

### SUMMARY

Accordingly, one object of the present disclosure is to effectively remove heat from an interrupter unit of a vacuum circuit breaker. Another object of the present disclosure is to provide a mechanism which increase a rate of heat transfer from arcing contacts of the interrupter unit to prevent an undesired rise of temperatures of the vacuum interrupter bottle and the transfer contacts, and therefore undesired deterioration of the contacts and reduced performance of the vacuum circuit breaker.

The above objects are addressed by a heat transfer assembly that facilitates an increased heat transfer from arcing contacts of a vacuum circuit breaker having a dead tank and an interrupter unit with the arcing contacts. As the arcing contacts are arranged inside a vacuum sealed bottle, the only way to remove heat from the arcing contacts is via the radiation and conduction mechanisms to the conductor casings and then to an insulation gas present inside the dead tank and surrounding the conductor casings for heat dissipation by convection.

In various embodiments and implementations of the concepts disclosed herein, to increase the heat transfer from the conductor casings to the insulation gas, the heat transfer assembly includes a plurality of fins attached to outer surfaces of the conductor casings. The fins provide enhanced surface area over which the insulation gas can flow, thereby increasing the rate of heat transfer or removal from the conductor casings and hence increases the rate of heat transfer from the arcing contacts to the conductor casings. However, the fins are generally thin and include small cross-sectional area or diameter, particularly at the tips, generating high electric field regions surpassing the dielectric strength of the insulation gas. In turn, such high electric field may cause generation of electric flashes inside the insulation gas present around the fins, ionizing the insulation gas, compromising the structural and electrical integrity of the vacuum circuit breaker.

To prevent the generation of the electric flashes and electric breakdown of the insulation gas, while allowing an increased rate of heat transfer from the conductor casings, the heat transfer assembly includes an electric shield arranged circumferentially around the fins and the conductor casing such that the fins are arranged between the outer surface of the conductor casing and an inner surface of the shield. Further, to facilitate the flow of insulation gas to the fins, the shield defines a plurality of openings. In this manner, the heat transfer assembly provides for increased heat transfer from the arcing contacts while preventing generation of the electric flashes and electric breakdown of the circuit breaker.

Generally, in one aspect, the present disclosure relates to heat transfer assembly for a vacuum circuit breaker having a conductor casing coupled to a vacuum sealed bottle of the vacuum circuit breaker, the heat transfer assembly including a plate having a plurality of fins and adapted to be removably attached to the conductor casing; and a shield adapted to be removably connected to the conductor casing and arranged outwardly and surrounding the plate to contain electric field within a space defined between the shield and the plate, wherein the shield includes a plurality of openings to allow a flow of an insulation gas between the space and exterior of the shield. The shield may include at least two shield portions adapted to be engaged with each other. In some embodiments, sizes of the plurality of openings are selected to prevent the electric field to extend outwardly of the shield.

In another aspect, the disclosure relates to an interrupter unit for a vacuum circuit breaker that includes a dead tank defining a chamber to store an insulated gas. The interrupter unit is adapted to be arranged inside the chamber. The interrupter unit includes a vacuum sealed bottle having a first end and a second end, and a first conductor casing attached to the first end of the vacuum sealed bottle and extending outwardly and along a central axis of the vacuum sealed bottle. The interrupter unit also includes a second conductor casing attached to second end of the vacuum sealed bottle and extending outwardly and along the central axis of the vacuum sealed bottle, and a moving contact arranged to move along the central axis of the vacuum sealed bottle and arranged partially inside the vacuum sealed bottle and partially inside the first conductor casing. Further, the interrupter unit includes a stationary contact non-movably and partially arranged inside the vacuum sealed bottle and connected to the second conductor casing. The moving contact is displaced to engage and disengage with the stationary contact to close and open an electric circuit. Furthermore, the interrupter unit includes at least one plate including a plurality of fins secured to at least one of the first conductor casing and the second conductor casing and arranged outside the at least one of the first conductor casing and the second conductor casing. Moreover, the interrupter unit includes at least one shield arranged outwardly and surrounding the at least one plate to contain electric field within a space defined between the at least one shield and the at least one plate. The at least one shield includes a plurality of openings to allow a flow of the insulation gas between the space and exterior of the shield to enable a heat transfer from the fins.

In yet another aspect of the disclosure, a vacuum circuit breaker is disclosed. The vacuum circuit breaker includes a dead tank defining a chamber and storing an insulated gas, and an interrupter unit arranged inside the chamber. The interrupter unit includes a vacuum sealed bottle having a first end and a second end, and a first conductor casing attached to the first end of the vacuum sealed bottle and extending outwardly and along a central axis of the vacuum sealed bottle. The interrupter unit also includes a second conductor casing attached to second end of the vacuum sealed bottle and extending outwardly and along the central axis of the vacuum sealed bottle, and a moving contact arranged to move along the central axis of the vacuum sealed bottle and arranged partially inside the vacuum sealed bottle and partially inside the first conductor casing. Further, the interrupter unit includes a stationary contact non-movably and partially arranged inside the vacuum sealed bottle and connected to the second conductor casing. The moving contact is displaced to engage and disengage with the stationary contact to close and open an electric circuit. Furthermore, the interrupter unit includes at least one plate including a plurality of fins secured to at least one of the first conductor casing and the second conductor casing and arranged outside the at least one of the first conductor casing and the second conductor casing. Moreover, the interrupter unit includes at least one shield arranged outwardly and surrounding the at least one plate to contain electric field within a space defined between the at least one shield and the at least one plate. The at least one shield includes a plurality of openings to allow a flow of the insulation gas between the space and exterior of the shield to enable a heat transfer from the fins.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 illustrates a front sectional view of a vacuum circuit breaker, in accordance with an embodiment of the disclosure;

FIG. 2 illustrates a sectional perspective view of an interrupter unit of the vacuum circuit breaker of FIG. 1, in accordance with an embodiment of the disclosure;

FIG. 3 illustrates a front perspective view of the interrupter unit depicting two shields arranged surrounding two conductor casings of the interrupter unit with fins arranged between the shields and the conductor casings, in accordance with an embodiment of the disclosure;

FIG. 4 illustrates a sectional perspective view of the interrupter unit of FIG. 3 with shields removed, in accordance with an embodiment of the disclosure;

FIG. 5 illustrates, a front perspective of a first heat transfer assembly schematically depicting a first plate having fins attached to a first conductor casing, in accordance with an embodiment of the disclosure;

FIG. 6 illustrates a side perspective of the first heat transfer assembly schematically depicting the first plate having fins attached to the first conductor casing, in accordance with an embodiment of the disclosure;

FIG. 7 illustrates a sectional view of the vacuum circuit breaker of FIG. 1 depicting temperature profiles of various components, in accordance with an embodiment of the disclosure; and

FIG. 8 illustrates a sectional view of a conventional vacuum circuit breaker depicting temperature profiles of various components, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

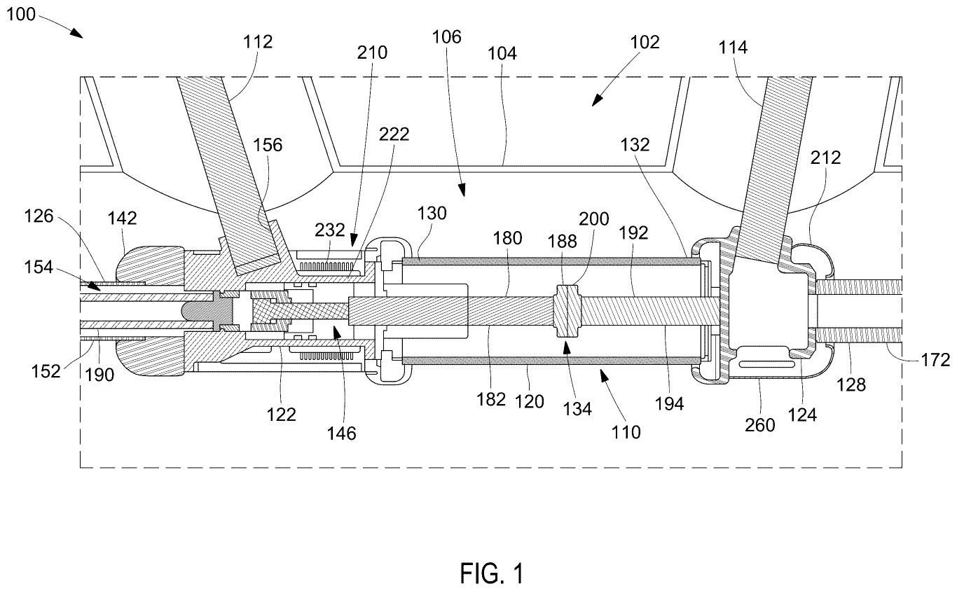

Referring to FIG. 1, a vacuum circuit breaker 100 is shown, according to various embodiments of the present disclosure. The vacuum circuit breaker 100 is illustrated as a dead tank vacuum circuit breaker 102, however, other types of vacuum circuit breakers are also suitable in conjunction with the present disclosure and concepts described herein. As shown, the vacuum circuit breaker 100 (also to as breaker 100) includes a dead tank 104 defining a chamber 106, an interrupter unit 110 arranged inside the chamber 106 and supported on the dead tank 104, and a pair of conductors 112, 114 attached to the interrupter unit 110 to electrically couple a first electric equipment and a second electrical equipment. The interrupter unit 110 is arranged to electrically connect and disconnect the first and second electrical equipment and includes a vacuum sealed bottle 120, a first conductor casing 122, a second conductor casing 124, and a pair of ground insulators 126, 128 supporting the interrupter unit 110 on the dead tank 104 and electrically insulating the dead tank 104 from electrically conducting components of the interrupter unit 110.

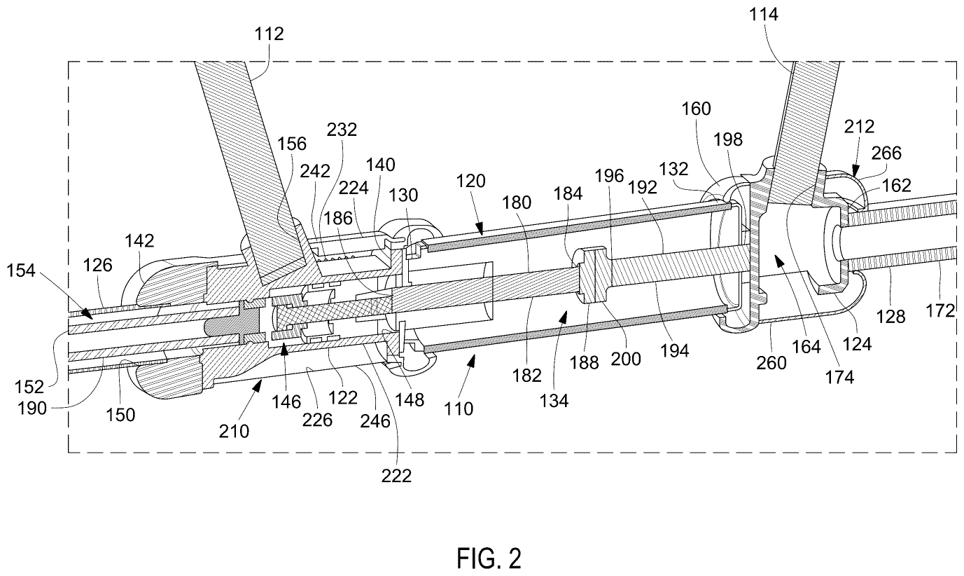

Referring to FIGS. 1 to 4, the vacuum sealed bottle 120 includes a first axial end 130, a second axial end 132 arranged opposite to the first axial end 130, and a vacuum compartment 134, shown in FIGS. 1 and 2, extending from the first axial end 130 to the second axial end 132. The first conductor casing 122 and the second conductor casing 124 extend outwardly, in an axial direction, from the vacuum sealed bottle 120, and are, respectively, connected/attached to the first axial end 130 and the second axial end 132 of the bottle 120. The first conductor casing 122 and the second conductor casing 124 are formed of electrically conducing material, for example, aluminium, or any other electrically conducting metal or alloy known in the art. A first conductor 112 of the pair of conductors 112, 114 is attached to the first conductor casing 122, while a second conductor 114 of the pair of conductors 112, 114 is attached to the second conductor casing 124, and the first conductor 112 and the second conductor 114 extend outwardly of the dead tank 104 from the associated conductor casings 122, 124.

As shown in FIGS. 1 and 2, the first conductor casing 122, referred to as first casing 122, includes a first end 140 connected to the first axial end 130 of the bottle 120 and a second end 142 arranged opposite to the first end 140 and disposed proximate to the dead tank 104 relative to the first end 140 in the axial direction of the bottle 120. The first casing 122 defines a cavity, for example, a first cavity 146, with a first access hole 148 of the first cavity 146 arranged at the first end 140 and a second access hole 150 of the first cavity 146 arranged at the second end 142.

The first ground insulator 126 extends from the dead tank 104 to the second end 142 of the first casing 122 and is attached to the first casing 122. In the embodiment, the first ground insulator 126 is an insulator tube 152 extending, in the axial direction of the bottle 120, from the first casing 122 to the dead tank 104 with an end portion of the insulator tube 152 extending inside the first casing 122 through the second access hole 150. Accordingly, the second access hole 150 and a channel 154 of the insulator tube 152 are coaxially arranged to each other.

Moreover, the first casing 122 includes a slot, for example, a first slot 156, as illustrated in detail in FIG. 2, extending through a wall of the first casing 122 with a central axis of the first slot 156 arranged at an inclination relative of a central axis of the first casing 122. An end portion of the first conductor 112 is arranged inside the first slot 156 and is attached to the second casing 122. The first conductor 112 extends from the first slot 156 to a location outwardly of the dead tank 104. Similar to the first casing 122, the second casing 124 includes a first end 160 connected to the second axial end 132 of the bottle 120 and a second end 162 arranged opposite to the first end 160 and disposed proximate to the dead tank 104 relative to the first end 160 in the axial direction of the bottle 120. The second casing 124 defines a cavity, for example, a second cavity 164, shown in FIGS. 1 and 2. The second ground insulator 128 extends from the dead tank 104 to the second end 162 of the second casing 124 and is attached to the second casing 124. As shown in FIGS. 1 and 2, the second ground insulator 128 is an insulator rod 172 extending, in the axial direction of the bottle 120, from the second casing 124 to the dead tank 104.

Moreover, the second casing 124 includes a slot, for example, second slot 174, as illustrated in detail in FIG. 2, extending through a wall of the second casing 124 with a central axis of the second slot 174 arranged at an inclination relative of a central axis of the second casing 124. An end portion of the second conductor 114 is arranged inside the second slot 174 and is attached to the second casing 124. The second conductor 114 extends from the second slot 174 and outwardly of the dead tank 104.

Furthermore, as shown in FIGS. 1 and 2, the interrupter unit 110 includes a first contact 180, also referred to as a moving contact 180, at least partially arranged inside the bottle 120 and partially arranged inside the first casing 122 and extending in the axial direction of the bottle 120. The moving contact 180 is configured to be displaced/moved in the axial direction relative to the first casing 122 and the bottle 120, and includes a rod portion, i.e., first rod portion 182, having a first end 184 arranged inside the bottle 120 and a second end 186 disposed inside the first casing 122, contacting the first casing 122. In some embodiments, the moving contact 180 also includes a disc portion, i.e., a first disc portion 188 arranged at the first end 184 of the first rod portion 182 and connected to the first rod portion 182. It may be appreciated that first contact 180 is made of an electrically conducting material, for aluminium or any other similar material known in the art.

To facilitate the displacement of the first contact 180 in the axial direction of the bottle 120, the interrupter unit 110 includes an actuator rod 190 extending from an outside of the dead tank 104 to an inside of the first casing 122 through the channel 154 of the insulator tube 152, and is connected to the second end 186 of the first rod portion 182 of the moving contact 180. It may be noted that the actuator rod 190 is made of a suitable electrically insulator material to prevent the flow of electricity to the dead tank 104 and outside of the dead tank 104 from the first casing 122 and the first contact 180 through the actuator rod 190. The actuator rod 190 is moved forwardly and rearwardly in the axial direction by a suitable actuator, known in the art, to displace the first contact 180 in the axial direction relative to the bottle 120 and the first casing 122. It may be appreciated that the interrupter unit 110 may include suitable components, for example, bearings and/or bushings, to movably support the first contact 180 and the actuator rod 190.

The interrupter unit 110 further includes a second contact 192 i.e., a stationary contact 192, partially extending inside the bottle 120 and partially arranged inside the second casing 124 and extending in the axial direction of the bottle 120. The second contact 192 may extends inside the second casing 124 and is attached to the second casing 124. The second contact 192 remains stationary relative to the bottle 120 and the second casing 124, and includes a rod portion, for example, a second rod portion 194, having a first end 196 arranged inside bottle 120 and a second end 198 arranged that may be disposed inside the second cavity 164 and attached to the second casing 124.

The second contact 192 further includes a disc portion, for example a second disc portion 200, attached to the second rod portion 194 and disposed at the first end 196 of the second rod portion 194. The second disc portion 200 is engaged with the first disc portion 188 to electrically connect the first conductor 112 and the second conductor 114 to close an electrical circuit, while the first disc portion 188 is moved away from the second disc portion 200 to break the electrical circuit and electrically disconnect the first conductor 112 and the second conductor 114. Accordingly, by moving the first contact 180, in axial longitudinal direction, towards and away from the second contact 192 via the actuator rod 190, while the first conductor 112 and the second conductor 114 are electrically connected with and disconnected from each other.

When the disc portions 188, 200 are arranged in contact or during engagement, disengagement of the first and disc portions 188, 200, a large amount of heat is generated at the disc portions 188, 200 which is transferred to the first casing 122 and the second casing 124 via the first and second rod portions 182, 194 through conduction mechanism. To enhance the heat transfer from the first casing 122 and the second casing 124 to an insulation gas present inside the chamber 106 of the dead tank 104, the interrupter unit 110 includes at least one heat transfer assembly, for example, a first heat transfer assembly 210 attached to the first casing 122 and a second heat transfer assembly 212 attached to the second casing 124. It may be appreciated that the first heat transfer assembly 210 and the second heat transfer assembly 212 are similar in construction, structure, and functionality, and therefore, for the sake of clarity, the structure, construction, functionality of only one of the heat transfer assemblies, for example, the first heat transfer assembly 210 is described in detail.

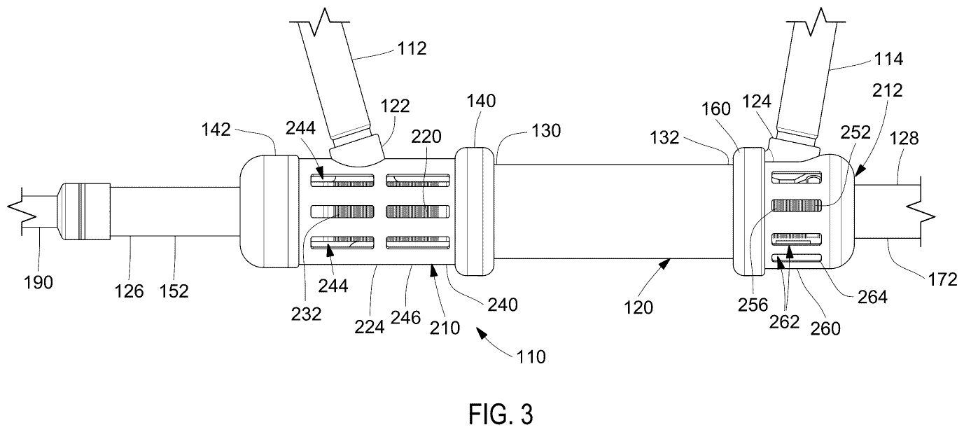

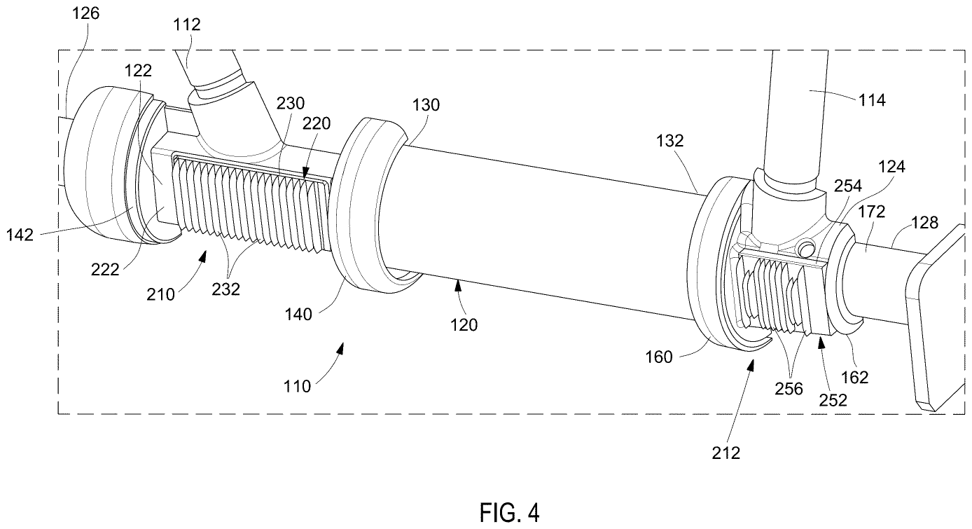

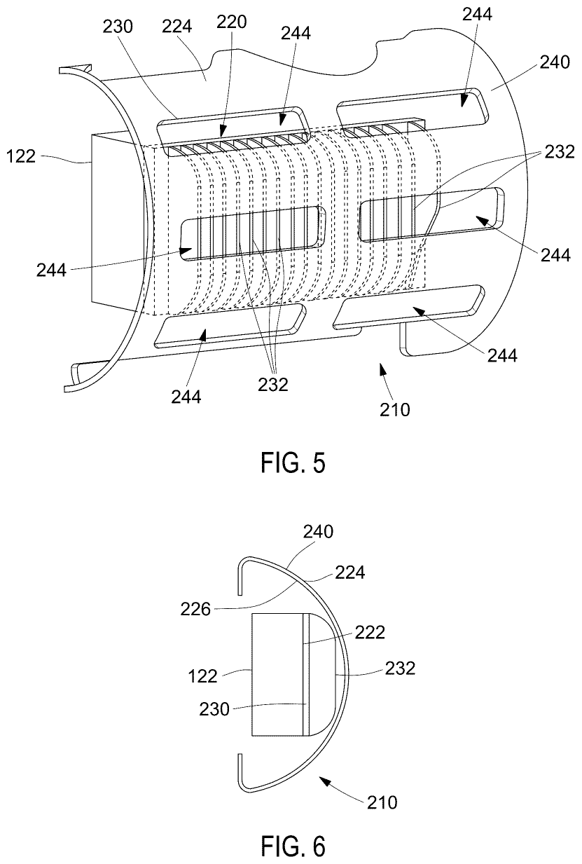

As shown in FIG. 3, to 6, the first heat transfer assembly 210 is attached and secured to the first casing 122 and includes at least one plate, for example, at least one first plate 220, arranged outside the first casing 122 and attached to an outer surface 222 of the first casing 122, and a shield 224, i.e., a first shield 224, shown in FIG. 3 to 6, arranged at a radial gap or space from the first plate 220 and surrounding the first plate 220. As shown, the first plate 220 includes a plate body 230 i.e., a first plate body 230, shown in FIG. 4, attached to the outer surface 222 of the first casing 122, and a plurality of fins 232, first fins 232, extending outwardly from the first plate body 230 and disposed outside the first casing 122. The first fins 232 provides a large surface area to enable a rapid heat transfer from the first casing 122 to the insulation gas via a convection mechanism. In some embodiments, the first plate body 230 i.e., the first plate 220 may be removably fastened to the first casing 122. Alternatively, the first fins 232 may be integrally formed to the outer surface 222 of the first casing 122. In such a case, the plate body 230 may be omitted.

Although the first fins 232 facilitate rapid heat transfer to the insulation gas from the first casing 122, the first fins 232, owing to their smaller diameters, specifically at its tips, have electric field region which may exceed the dielectric strength of the insulation gas, resulting into electrical flashes as well as the electric breakdown of the insulation gas, compromising the structural and electrical integrity of the vacuum circuit breaker 100. To prevent such a scenario, referring to FIG. 3, the present disclosure contemplates that the first shield 224 is arranged surrounding the first plate 220. In an embodiment, the first shield 224 is arranged circumferentially around the first casing 122 such that an inner surface 226 of the first shield 224 is disposed at a radial gap the outer surface 222 of the first casing 122 with first fins 232 arranged inside the radial gap with tips of the first fins 232 disposed at an offset from the inner surface 226 of the first shield 224. In the embodiment, the first shield 224 includes two shield portions 240, 242, for example, two semi-cylindrical halves 240, 242 adapted to be removably coupled to each other to surround the first casing 122. By having two shield portions 240, 242 it is relatively easy to assemble and position the first shield 224 circumferentially around the first casing 122 and covering the first fins 232. In some embodiments, the first shield 224 is a single hollow substantially cylindrical body arranged circumferentially around the first casing 122.

To facilitate the flow of insulated gas to the first fins 232 and therefore dissipate heat the first casing 122 and hence the moving contact 180, the first shield 224 defines a plurality of openings 244 i.e., a plurality of first openings 244, extending from an outer surface 246 of the first shield 224 to the inner surface 226 of the first shield 224. In the embodiment, the first openings 244 are shown as elongated slots 120 with longer sides of the slots extending substantially parallel to the axial direction of the vacuum bottle 120. However, the first openings 244 may extend in any other direction, for example, at an acute angle or perpendicular to the axial direction of the vacuum bottle 120. Sizes of the first openings 244 is selected such that the first openings 244 allow an exchange of insulated gas between the gap defined between the first shield 224 and the outer surface 222 of the first casing 122 and the chamber 106, while preventing the electric flashes at the first fins 232. In the embodiment, the first fins 232 are made of a material having high heat conductivity and the first shield 224 is made of a material having high electrical conductivity, for example, aluminium, copper, aluminium alloy, copper alloy, or any other similar material known in the art.

Similar to the first heat transfer assembly 210, the second heat transfer assembly 212 includes at least one second plate 252 having a plate body 254 i.e., second plate body 254, and a plurality of fins 256 i.e., a plurality of second fins 256, and a second shield 260 having a plurality of second openings 262 and two shield portions 264, 266.

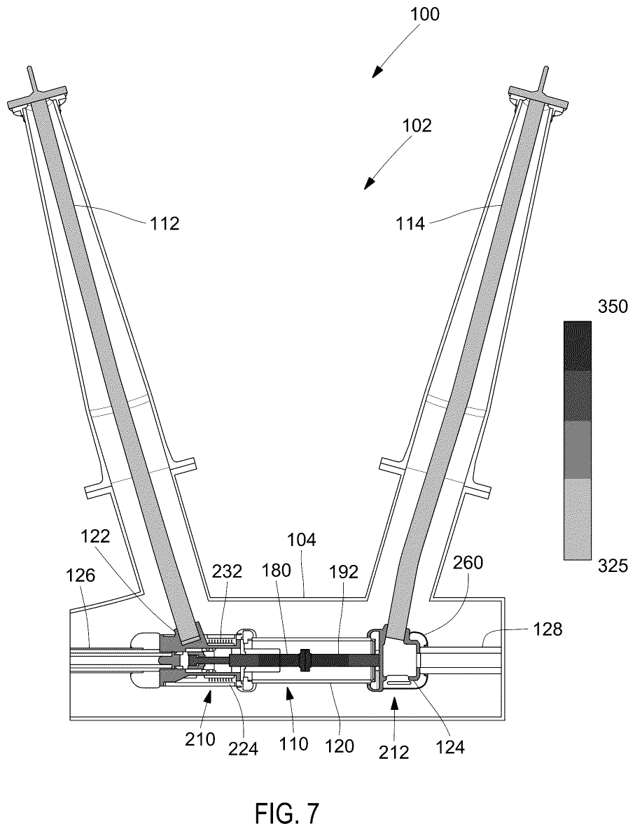

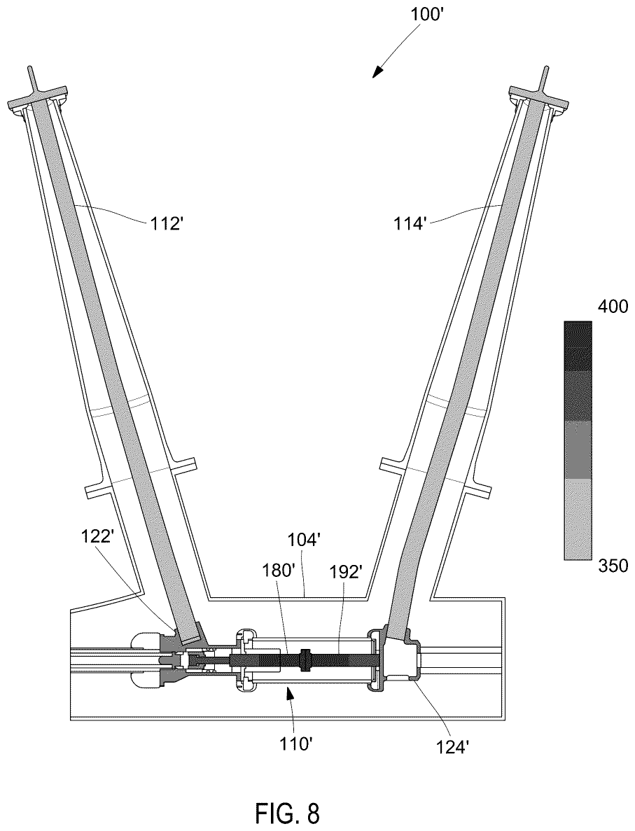

Referring to FIGS. 7 and 8, a comparison between temperature profiles of various components of the vacuum circuit breaker 100, shown in FIG. 7, vis a vis temperature profiles of various components of a convention vacuum circuit breaker 100′ (shown in FIG. 8) without the heat transfer assemblies 210, 212 are shown. As shown, the temperatures of the moving contact 180, the stationary contact 192, the first and second casings 122, 124, and the first and second conductors 112, 114 of the vacuum circuit breaker 100 remain relatively lower than moving and stationary contacts 180′ 192′, the first and second conductor casings 122′, 124′ and the first and the second conductors 112′, 114′. This happens due to rapid heat dissipation from the first and second conductor casings 122, 124 to the insulated gas present inside the dead tank 104 from the fins 232, 256.

As the lower temperatures of the components of the vacuum circuit breaker 100 can be maintained, overall working life of the vacuum circuit breaker 100 is increased relative to the convention vacuum circuit breaker 100′. Further, the vacuum circuit breaker 100 can be operated with reduced maintenance and provides less down time. Moreover, as the components of the breaker 100 needed to operate at relatively lower temperatures, materials of the components that can withstand high temperatures may be replaced with suitable materials that can withstand relatively lower temperatures, reducing overall cost of the vacuum circuit breaker 100.

Example Embodiment: Heat Transfer Assembly: Referring to FIGS. 6 and 7, the heat transfer assembly 210 for enhancing the heat dissipation from the conductor casing 122, for example, the first conductor casing 122, of the vacuum circuit breaker 100 is shown. The heat transfer assembly 210 enhances the heat dissipation from the conductor casing 122 via convection, and includes a plate, for example, the first plate 220, having a plurality of fins, for example, the first fins 232, and adapted to be removably attached to the conductor casing 122. The plate 220 may be removably attached to the first conductor casing 122 via one or more fasteners, adhesive suitable to sustain the temperatures of the vacuum circuit breakers, snap fitting, tabs, or any other suitable mechanism, known in the art, that removably engage the plate 220 with the conductor casing 122. The removable engagement of the plate 220 enables an easy replacement of the plate 220 when the fins 232 has deteriorated without damaging the conductor casing 122. Also, by having the removable plate 220, there is no need to replace the conductor casing 122 when the fins 232 are damaged. The plate 220 is made of a material that has high thermal conductivity. For example, the plate 220 may be made of a suitable material, such as, but not limited to, aluminum, aluminum alloy, copper, copper alloy, iron, iron alloy, or any other suitable material that facilitates heat transfer from the conductor casing 122 to an insulation gas.

Further, the heat transfer assembly 210 includes a shield, for example, the first shield 224 adapted to be removably connected to the conductor casing, the first conductor casing 122, and arranged outwardly and surrounding the plate, the first plate 220, to contain electric field within a space defined between the shield 224 and the plate 220. By containing the electric field within the space between the shield 224 and the plate 220, generation of electric flashes at the tips of the fins 232 are prevented. The shield 224 includes a plurality of openings, for example, the plurality of first openings 244, to allow a flow of an insulation gas between the space and exterior of the shield 224. Further, the removable engagement of the shield 224 enables the retrofitting of the shield 224 to an existing vacuum circuit breaker. Moreover, the removable engagement of the shield 224 facilitates in easy replacement of the shield 224 with a new shield or repair of the shield in case of a damage to the shield.

The shield 224 may be removably attached to the conductor casing 122 via one or more fasteners, adhesive suitable to sustain the temperatures of a vacuum circuit breaker, snap fitting, tabs, or any other suitable mechanism, known in the art, that removably engage the shield 224 with the conductor casing 122. The shield 224 may be made of a suitable material, such as a metal or metal alloy, that facilitates in containing the electric field within the space between plate 220 and the shield 224. In some embodiments, the shield 224 is made of aluminum.

In some optional, or additional embodiments, the shield 224 includes at least two shield portions, only on shield portion 240 is shown, adapted to be engaged with each other. By having two shield portions, for example, semi-cylindrical portions, the shield 224 is easy to assemble with the conductor casing 122. Two shield portions can be positioned on either side of the conductor casing 122 and then assembled with each other and the conductor casing 122 after assembling the conductor casing 122 with other components of an interrupter unit of the vacuum circuit breaker 100. Moreover, the two shield portions facilitates in easy assembling of the shield 224 around a convention vacuum circuit breaker without having to disassemble one or more components. Also, removal of the shield 224 having two shield portions from the conductor casing 122 is relatively easy for repair and replacement.

In some optional, additional, or alternative embodiments, sizes of the plurality of openings 244 are selected to prevent the electric field to extend outwardly of the shield 224 while allowing the insulation gas to flow to the fins 232 to enable heat transfer/dissipation from the fins to the insulation gas.

Example Embodiment: Vacuum circuit breaker: Referring to FIG. 1, the vacuum circuit breaker 100 includes a dead tank 104 defining a chamber 106 and storing an insulated gas. The dead tank 104 is referred to as dead tank as the tank is connected to a ground i.e., maintained at zero electric potential. Further, the vacuum circuit breaker 100 includes an interrupter unit 110 arranged inside the chamber 106 to open and close an electrical circuit. The interrupter unit 110 includes a vacuum sealed bottle 120 having a first end 130 and a second end 132, and a first conductor casing 122 attached to the first end 130 of the vacuum sealed bottle 120 and extending outwardly and along a central axis of the vacuum sealed bottle 120. The interrupter unit 110 also includes a second conductor casing 124 attached to the second end 132 of the vacuum sealed bottle 120 and extending outwardly and along the central axis of the vacuum sealed bottle 120. Further, the interrupter unit 110 includes a moving contact 180 arranged to move along the central axis of the vacuum sealed bottle 120 and arranged partially inside the vacuum sealed bottle 120 and partially inside the first conductor casing 122. Furthermore, the interrupter unit 110 includes a stationary contact 192 non-movably and partially arranged inside the vacuum sealed bottle 120 and connected to the second conductor casing 124. The moving contact 180 is displaced to engage and disengage with the stationary contact 192 to close and open the electric circuit.

Moreover, the interrupter unit 110 includes at least one plate including a plurality of fins, secured to at least one of the first conductor casing 122 and the second conductor casing 124 and arranged outside the at least one of the first conductor casing 122 and the second conductor casing 124. The fins facilitate in increased rate of heat transfer/dissipation from the interrupter unit 110 to the insulation gas via convection mechanism. To enable an increase rate of heat transfer/dissipation, the at least one plate is made of a material that has high thermal conductivity. For example, the at least one plate may be made of a suitable material, such as, but not limited to, aluminum, aluminum alloy, copper, copper alloy, iron, iron alloy, or any other suitable material that facilitates heat transfer from the conductor casing to an insulation gas.

Further, the interrupter unit 110 includes at least one shield arranged outwardly and surrounding the at least one plate to contain electric field within a space defined between the at least one shield and the at least one plate. By containing the electric field within the space between the at least one shield and the at least one plate, generation of electric flashes at the tips of the fins are prevented. The at least one shield may be made of a suitable material, such as a metal or metal alloy, that facilitates in containing the electric field within the space between at least one plate and the at least one shield. In some embodiments, the at least one shield is made of aluminum.

Moreover, the at least one shield includes a plurality of openings to allow a flow of an insulation gas between the space and exterior of the at least one shield to enable a heat transfer from the fins to the insulation gas. Sizes of the plurality of openings are selected to prevent the electric field to extend outwardly of the at least one shield.

In some additional, optional, or alternative embodiments, the at least one plate includes one or more first plates, a single first plate 220 is shown in FIG. 1, attached to the first conductor casing 122 and the at least one shield includes a first shield 224 arranged surrounding the one or more first plates 220. The first plate 220 includes a plurality of first fins 232 to enable the heat dissipation from the first conductor casing 122 and hence the moving contact 180 to the insulation gas. Also, the first shield 224 contains electric field within a space defined between the first shield and the first plate, and thereby prevents generation of electric flashes at the tips of the first fins.

In some embodiments, the first shield 224 includes a plurality of first openings 244 to allow a flow of an insulation gas between the space and exterior of the first shield 224 to enable a heat transfer from the first fins 232 to the insulation gas. Sizes of the plurality of first openings 244 are selected to prevent the electric field to extend outwardly of the first shield 224, while allowing the flow of the insulation gas between the space and the exterior of the first shield 224.

In some additional, optional, or alternative embodiments, the one or more first plates 220 are removably secured to the first conductor casing 122. The removable attachment of the first plate 220 may be facilitated by fasteners, adhesive that can sustain high temperatures, snap fitting, or any other similar means known in the art. The removable attachment of the first plate 220 with the first conductor casing 122 enables an easy repair and replacement of the first plate 220.

In some embodiments, the one or more first plates 220 may be integrally formed with the first conductor casing 122.

In some additional, optional, or alternative embodiments, the first shield 224 includes a pair of shield portions, only one shield portion 242 is shown in FIG. 1, removably engaged with each other. By having two shield portions, for example, semi-cylindrical portions, the first shield 224 is easy to assemble with the first conductor casing 122. Two shield portions can be positioned on either side of the first conductor casing 122 and then assembled with each other and the first conductor casing 122 after assembling the first conductor casing 122 with other components of the interrupter unit 110 of the vacuum circuit breaker 100. Moreover, the two shield portions facilitates in easy assembling of the first shield 224 around a conventional vacuum circuit breaker without having to disassemble one or more components. Also, removal of the first shield 224 having two shield portions from the first conductor casing 122 is relatively easy for repair and replacement.

Example Embodiment: Interrupter unit: Referring to FIGS. 2 to 4, the interrupter unit 110 for the vacuum circuit breaker is shown. The interrupter unit 110 is adapted to be arranged inside a chamber of the vacuum circuit breaker. The interrupter unit 110 includes a vacuum sealed bottle 120 having a first end 130 and a second end 132, and a first conductor casing 122 attached to the first end 130 of the vacuum sealed bottle 120 and extending outwardly and along a central axis of the vacuum sealed bottle 120. The interrupter unit 110 also includes a second conductor casing 124 attached to the second end 132 of the vacuum sealed bottle 120 and extending outwardly and along the central axis of the vacuum sealed bottle 120. Further, the interrupter unit 110 includes a moving contact 180 arranged to move along the central axis of the vacuum sealed bottle 120 and arranged partially inside the vacuum sealed bottle 120 and partially inside the first conductor casing 122. Furthermore, the interrupter unit 110 includes a stationary contact 192 non-movably and partially arranged inside the vacuum sealed bottle 120 and connected to the second conductor casing 124. The moving contact 180 is displaced to engage and disengage with the stationary contact 192 to close and open the electric circuit.

Moreover, the interrupter unit 110 includes at least one plate 220, 252 including a plurality of fins 232, 256 secured to at least one of the first conductor casing 122 and the second conductor casing 124 and arranged outside the at least one of the first conductor casing 122 and the second conductor casing 124. The fins 232, 256 facilitate in increased rate of heat transfer/dissipation from the interrupter unit 110 to the insulation gas via convection mechanism. To enable an increase rate of heat transfer/dissipation, the at least one plate 220, 252 is made of a material that has high thermal conductivity. For example, the at least one plate 220, 252 may be made of a suitable material, such as, but not limited to, aluminum, aluminum alloy, copper, copper alloy, iron, iron alloy, or any other suitable material that facilitates heat transfer from the at least one of the first conductor casing 122 and the second conductor casing 124 to an insulation gas.

Further, the interrupter unit 110 includes at least one shield 224, 260 arranged outwardly and surrounding the at least one plate 220, 252 to contain electric field within a space defined between the at least one shield 224, 260 and the at least one plate 220, 252. By containing the electric field within the space between the at least one shield 224, 260 and the at least one plate 220, 252, generation of electric flashes at the tips of the fins 232, 256 are prevented. The at least one shield 224, 260 may be made of a suitable material, such as a metal or metal alloy, that facilitates in containing the electric field within the space between the at least one plate 220, 252 and the at least one shield 224, 260. In some embodiments, the at least one shield 224, 260 is made of aluminum.

Moreover, the at least one shield 224, 260 includes a plurality of openings 244, 262 to allow a flow of an insulation gas between the space and exterior of the at least one shield 224, 260 to enable a heat transfer from the fins 232, 256 to the insulation gas. Sizes of the plurality of openings 244, 262 are selected to prevent the electric field to extend outwardly of the at least one shield 224, 260.

In some additional, optional, or alternative embodiments, the at least one plate 220, 252 includes one or more first plates 220, a single first plate 220 is shown in FIGS. 2 to 4, attached to the first conductor casing 122 and the at least one shield 224, 260 includes a first shield 224 arranged surrounding the first plate 220. The first plate 220 includes a plurality of first fins 232 to enable the heat dissipation from the first conductor casing 122 and hence the moving contact 180 to the insulation gas. Also, the first shield 224 contains the electric field within a space defined between the first shield 224 and the first plate 220, and thereby prevents generation of electric flashes at the tips of the first fins 232.

In some embodiments, the first shield 224 includes a plurality of first openings 244 that allows the flow of insulation gas to contact the first fins 232 to enable heat transfer/dissipation from the first fins 232 to the insulation gas via convection.

In some additional, optional, or alternative embodiments, the one or more first plates 220 are removably secured to the first conductor casing 122. The removable attachment of the first plate 220 may be facilitated by fasteners, adhesive that can sustain high temperatures, snap fitting, or any other similar means known in the art. The removable attachment of the first plate 220 enables an easy repair and replacement of the first plate 220.

In some embodiments, the one or more first plates 220 may be integrally formed with the first conductor casing 122.

In some additional, optional, or alternative embodiments, the first shield 224 includes a pair of shield portions 240, 242 removably engaged with each other. By having two shield portions 240, 242, for example, semi-cylindrical portions, the first shield 224 is easy to assemble with the first conductor casing 122. Two shield portions 240, 242 are positioned on either side of the first conductor casing 122 and then assembled with each other and the first conductor casing 122 upon assembling the first conductor casing 122 with other components of the interrupter unit 110. Moreover, the two shield portions 240, 242 facilitates in easy assembling of the first shield 224 around a convention vacuum circuit breaker without having to disassemble one or more components. Also, removal of the first shield 224 having two shield portions 240, 242 from the first conductor casing 122 is relatively easy for repair and replacement.

In some optional, additional, or alternative embodiments, the at least one plate 220, 252 includes one or more second plates 252, a single second plate 252 is shown, attached to the second conductor casing 124 and the at least one shield 224, 260 includes a second shield 260 arranged surrounding the one or more second plates 252. The second plate 252 includes a plurality of second fins 256 to enable the heat dissipation from the second conductor casing 124 and hence the stationary contact 192 to the insulation gas. Also, the second shield 260 contains electric field within a space defined between the second shield 260 and the second plate 252, and thereby prevents generation of electric flashes at the tips of the second fins 256.

In some embodiments, the second shield 260 includes a plurality of second openings 262 that allows the flow of insulation gas to contact the second fins 256 to enable heat transfer/dissipation from the second fins 256 to the insulation gas via convection.

In some additional, optional, or alternative embodiments, the one or more second plates 252 are removably secured to the second conductor casing 124. The removable attachment of the second plate 252 may be facilitated by fasteners, adhesive that can sustain high temperatures, snap fitting, or any other similar means known in the art. The removable attachment of the second plate 252 enables an easy repair and replacement of the second plate 252. In some embodiments, the second plates 252 may be integrally formed with the second conductor casing 124.

In some additional, optional, or alternative embodiments, the second shield 260 includes a pair of shield portions 264, 266 removably engaged with each other. By having two shield portions 264, 266, for example, semi-cylindrical portions, the second shield 260 is easy to assemble with the second conductor casing 124. Two shield portions 264, 266 can be positioned on either side of the second conductor casing 124 and then assembled with each other and the second conductor casing 124 after assembling the second conductor casing 124 with other components of the interrupter unit 110. Moreover, the two shield portions 264, 266 facilitates in easy assembling of the second shield 260 around a conventional vacuum circuit breaker, for example, the vacuum circuit breaker 100′, shown in FIG. 8, without having to disassemble one or more components. Also, removal of the second shield 260 having two shield portions from the second conductor casing 124 is relatively easy for repair and replacement.

It should be understood that the foregoing description is only illustrative of the aspects of the disclosed embodiments. While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. Various alternatives and modifications can be devised by those skilled in the art without departing from the aspects of the disclosed embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

### LIST OF ELEMENTS

100 vacuum circuit breaker
100′ conventional vacuum circuit breaker
102 dead tank vacuum circuit breaker
104 dead tank
106 chamber
110 interrupter unit
110′ interrupter unit
112 first conductor
112′ first conductor
114 second conductor
114′ second conductor
120 vacuum sealed bottle
122 first conductor casing
122′ first conductor casing
124 second conductor casing
124′ second conductor casing
126 first ground insulator
128 second ground insulator
130 first axial end
132 second axial end
134 compartment
140 first end
142 second end
146 first cavity
148 first access hole
150 second access hole
152 insulator tube
154 channel
156 first slot
160 first end
162 second end
164 second cavity
172 insulator rod
174 second slot
180 moving contact
180′ moving contact
182 first rod portion
184 first end
186 second end
188 first disc portion
190 actuator rod
192 stationary contact
192′ stationary contact
194 second rod portion
196 first end
198 second end
200 second disc portion
210 first heat transfer assembly
212 second heat transfer assembly
220 first plate
222 outer surface
224 first shield
226 inner surface
230 first plate body
232 first fin
240 shield portion
242 shield portion
244 first opening
246 outer surface
252 second plate
254 second plate body
256 second fin
260 second shield
262 second opening
264 shield portion
266 shield portion

What is claimed is:

1. A heat transfer assembly for a vacuum circuit breaker having a conductor casing coupled to a vacuum sealed bottle of the vacuum circuit breaker, the heat transfer assembly comprising:
a plate having a plurality of fins and adapted to be removably attached to the conductor casing; and
a shield adapted to be removably connected to the conductor casing and arranged outwardly and surrounding the plate to contain electric field within a space defined between the shield and the plate, wherein the shield includes a plurality of openings to allow a flow of an insulation gas between the space and exterior of the shield.

2. The heat transfer assembly of claim 1, wherein the shield includes at least two shield portions adapted to be engaged with each other.

3. The heat transfer assembly of claim 1, wherein sizes of the plurality of openings are selected to prevent the electric field to extend outwardly of the shield.

4. A vacuum circuit breaker, comprising:
a dead tank defining a chamber and storing an insulated gas; and
an interrupter unit arranged inside the chamber and comprises:
a vacuum sealed bottle having a first end and a second end;
a first conductor casing attached to the first end of the vacuum sealed bottle and extending outwardly and along a central axis of the vacuum sealed bottle;
a second conductor casing attached to the second end of the vacuum sealed bottle and extending outwardly and along the central axis of the vacuum sealed bottle;
a moving contact arranged to move along the central axis of the vacuum sealed bottle and arranged partially inside the vacuum sealed bottle and partially inside the first conductor casing;
a stationary contact non-movably and partially arranged inside the vacuum sealed bottle and connected to the second conductor casing, wherein the moving contact is displaced to engage and disengage with the stationary contact to close and open an electric circuit;
at least one plate including a plurality of fins secured to at least one of the first conductor casing and the second conductor casing and arranged outside the at least one of the first conductor casing and the second conductor casing; and
at least one shield arranged outwardly and surrounding the at least one plate to contain electric field within a space defined between the at least one shield and the at least one plate, wherein the at least one shield includes a plurality of openings to allow a flow of the insulation gas between the space and exterior of the shield to enable a heat transfer from the fins.

5. The vacuum circuit breaker of claim 4, wherein sizes of the plurality of openings are selected to prevent the electric field to extend outwardly of the at least one shield.

6. The vacuum circuit breaker of claim 4, wherein the at least one plate includes one or more first plates attached to the first conductor casing and the at least one shield includes a first shield arranged surrounding the one or more first plates.

7. The vacuum circuit breaker of claim 6, wherein the one or more first plates are removably secured to the first conductor casing.

8. The vacuum circuit breaker of claim 6, wherein the first shield includes a pair of shield portions removably engaged with each other.

9. The vacuum circuit breaker of claim 4, wherein the at least one plate includes one or more second plates attached to the second conductor casing and at least one shield includes a second shield arranged surrounding the one or more second plates.

10. The vacuum circuit breaker of claim 9, wherein the one or more second plates are removably secured to the second conductor casing.

11. The vacuum circuit breaker of claim 9, wherein the second shield includes a pair of shield portions removably engaged with each other.

12. An interrupter unit for a vacuum circuit breaker, the vacuum circuit breaker includes a dead tank defining a chamber to store an insulated gas, wherein the interrupter unit is adapted to be arranged inside the chamber, the interrupter unit comprising:
a vacuum sealed bottle having a first end and a second end;
a first conductor casing attached to the first end of the vacuum sealed bottle and extending outwardly and along a central axis of the vacuum sealed bottle;
a second conductor casing attached to the second end of the vacuum sealed bottle and extending outwardly and along the central axis of the vacuum sealed bottle;
a moving contact arranged to move along the central axis of the vacuum sealed bottle and arranged partially inside the vacuum sealed bottle and partially inside the first conductor casing;
a stationary contact non-movably and partially arranged inside the vacuum sealed bottle and connected to the second conductor casing, wherein the moving contact is displaced to engage and disengage with the stationary contact to close and open an electric circuit;
at least one plate including a plurality of fins secured to at least one of the first conductor casing and the second conductor casing and arranged outside the at least one of the first conductor casing and the second conductor casing; and
at least one shield arranged outwardly and surrounding the at least one plate to contain electric field within a space defined between the at least one shield and the at least one plate, wherein the at least one shield includes a plurality of openings to allow a flow of the insulation gas between the space and exterior of the shield to enable a heat transfer from the fins.

13. The interrupter unit of claim 12, wherein sizes of the plurality of openings are selected to prevent the electric field to extend outwardly of the at least one shield.

14. The interrupter unit of claim 12, wherein the at least one plate includes one or more first plates attached to the first conductor casing and the at least one shield includes a first shield arranged surrounding the one or more first plates.

15. The interrupter unit of claim 14, wherein the one or more first plates are removably secured to the first conductor casing.

16. The interrupter unit of claim 14, wherein the first shield includes a pair of shield portions removably engaged with each other.

17. The interrupter unit of claim 12, wherein the at least one plate includes one or more second plates attached to the second conductor casing and at least one shield includes a second shield arranged surrounding the one or more second plates.

18. The interrupter unit of claim 17, wherein the one or more second plates are removably secured to the second conductor casing.

19. The interrupter unit of claim 17, wherein the second shield includes a pair of shield portions removably engaged with each other.
